(19) United States
(12) Patent Application Publication
(10) Pub. No.: US 2016/0220941 A1
(43) Pub. Date: Aug. 4, 2016

(54) PORTABLE WET SCRUBBER

(71) Applicant: Clean Air Technologies Inc., North York (CA)

(72) Inventor: Con Banh, Markham (CA)

(21) Appl. No.: 14/800,977

(22) Filed: Jul. 16, 2015

(30) Foreign Application Priority Data
Jan. 30, 2015 (CA) 2880360

(51) Int. Cl. B01D 50/00; B01D 45/10; B01D 47/10

(52) U.S. Cl. CPC B01D 50/008; B01D 47/10; B01D 45/10

(57) ABSTRACT

The present invention relates to a portable web scrubber unit for a dirty gas stream having particulate matter. The dirty gas stream is drawn into the wet scrubber and is forced down through an inner channel deep into a water reservoir. The water acts as a separator, and a majority of the particulates fall to the bottom of the unit immediately. Those particles that manage to escape the first stage of cleansing, are forced through thick curtains of water, and are deflected by a series of baffles through a series of channels into the water turbulence, separating the remaining particulates from the gas stream. The moist clean gas stream is drawn up through the unit by an internally fitted blower, passes through a stainless steel mist eliminator, where the moisture is removed from the clean air and is discharged from the scrubber. The particulates which have settled to the bottom of the water reservoir are removed through a drain valve.

### RELATED APPLICATIONS

This application claims the benefit of Canadian patent application no. 2880360 filed Jan. 30, 2015. This application is herein incorporated by reference in their entirety for all purposes.

### FIELD OF THE INVENTION

This disclosure relates to apparatus for removing particulates from a gas stream and more particularly a portable wet scrubber.

### BACKGROUND OF THE INVENTION

Wet scrubbers have numerous industrial applications. They are capable of collecting basically any type of dust, including flammable, explosive, moist, or sticky dusts. Wet scrubbers are often selected for applications where the particulate in a dirty gas stream is combustible. A wet scrubber eliminates explosion potential of particulates by using fluids, such as water, to remove particulates from the dirty gas stream.

In wet scrubbers the cleaning of a contaminated or dirty gas stream having very fine particulates is typically effected by water or other liquid which is set in turbulence by the gas stream. The mixing or scrubbing action of the gas stream with the water causes the particulates to transfer to the water. The particulates transferred to the water settle in the water while the gas stream continues flowing in the scrubber and exits therefrom. In some scrubbers perforated plates are used to enhance particulate transfer. A filter media may be used to remove remaining moisture from the gas stream and additionally filter the gas stream before discharge to the atmosphere. The settled particulates are removed from the scrubber.

Venturi wet scrubbers are one type of wet scrubbers. Venturi wet scrubbers force a particle-laden gas stream to pass over the surface of a pool of scrubbing liquid as it enters an orifice. With the high gas velocities typical of this type of scrubber, the liquid from the pool becomes entrained in the gas stream as droplets. As the gas velocity and turbulence increases with the passing of the gas through the narrow orifice, the interaction between the particulate matter and liquid droplets also increases. Particulate matter and droplets are then removed from the gas stream by impingement on a series of baffles that the gas encounters after the orifice. The collected liquid and particulate matter drain from the baffles back into the liquid pool below the orifice and are removed from the scrubber.

One wet scrubber application involves removal of aluminum dust particles in auto body repair facilities. With the increased use of aluminum body parts in motor vehicles, the repair of damaged vehicles requires safe and effective removal of aluminum dust created by sanding. Aluminum dust or particulates are highly explosive. When repairing a vehicle having aluminum components, it is also important to capture all the particulates at the source to prevent cross metal contamination. If cold steel particles come in contact with bare aluminum, even in microscopic levels, it can lead to a reaction called “galvanic corrosion”. This reaction can corrode the metal or cause blistering or bubbling on the painted surface.

### SUMMARY OF THE INVENTION

Explosive dust from the exhaust hose of an orbital sander or the like is drawn into the wet scrubber unit and forced down through a venturi channel deep into a water reservoir. The water acts as a separator, and a majority of the dust particles fall to the bottom of the unit immediately. Those particles that manage to escape the first stage of cleansing, are forced through thick curtains of water, and are deflected by a series of baffles into the water turbulence, separating the remaining dust from the air. The moist clean air is drawn up through the unit by an internally fitted fan blower, passes through a stainless steel mist eliminator, where the moisture is removed from the clean air before discharge from the scrubber. The particulates which have settled to the bottom of the water reservoir are removed through a sludge drain valve.

In one embodiment, the disclosure provides a portable wet scrubber having a main housing having a closed first end wall and an open second end wall and a detachable top mounted motor housing including a fan blower adapted to draw gas from said main housing and to discharge the gas from the motor housing. The main housing has upper, middle and lower sections. The upper section includes a filtering element, the middle section includes a fluid reservoir and a scrubbing module disposed therein. The scrubbing module cooperates with the upper and lower sections. A contaminated gas inlet port is arranged in the side wall of the main housing and adjoins an inlet duct of the scrubbing module. The lower section includes the lower portion of the fluid reservoir and means for removal of particulates extracted from the contaminated gas.

The scrubbing module has a plurality of baffles disposed longitudinally between a pair of end walls of the scrubbing module. The baffles are arranged to define a plurality of associated channels therethrough. The channels comprise a first inner channel cooperating with the inlet duct, a pair of second inner channels adjacent the end section of the first inner channel and a pair of third channels. The second channels converge into an associated chamber in communication with the first and third channels. The third channels are disposed adjacent the first channel in cooperation with the second channels.

In a further embodiment, the closed end wall of the portable wet scrubber is affixed to a cart having a platform, a plurality of wheels affixed to the platform, a pair of members extending from the platform means and conjoining with a cross member at the opposite ends thereof.

In another embodiment the first channel in the scrubber module comprises an angled top wall plate and a pair of inner baffles each extending generally orthogonally from each side of the top wall.

In another embodiment a pair of spaced apart longitudinal baffle plates are disposed parallel to each inner baffle to form a pair of second channels adjacent each side of first channel. Each longitudinal baffle plate has an angled end section extending towards said inner baffle.

In another embodiment the second channels converge into a single open lower chamber.

In another embodiment the third channels are generally arcuate in shape and are disposed in spaced relationship from the angled end of each longitudinal baffle plate.

In another embodiment each inner baffle includes a flat section proximate the top wall and an opposing bulbous like end section.

In another embodiment the bulbous ends of the inner baffles comprise a plurality of plate segments formed into a diamond shape.

In another embodiment the bulbous ends comprise a generally spherical shape.

In another embodiment the fluid reservoir has a generally conical shaped bottom wall having a valved drain.

In another embodiment there is a fluid inlet port communicating with the reservoir.

In another embodiment there are means for controlling the fluid level in the reservoir.

In another embodiment there is a controller for selective operation of the fan.

In another embodiment the filter element comprises a filter frame and filer media.

In another embodiment there are included a pair of opposed angled baffles disposed between the scrubbing module and the filter element. The baffles extend inwardly from the side wall of the main housing to form an opening between the baffle ends.

In another embodiment there is provided an outlet port in the side wall of the main housing at the filter element section. The outlet port has means for discharging built up gas from the filter element section.

In another embodiment the main housing is generally cylindrical in shape.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

An embodiment will now be described in detail by way of example, with reference to the accompanying drawings.

FIG. 1 is a front view of a wet scrubber of the present disclosure mounted on a cart.

FIG. 2 is rear side view of the scrubber of FIG. 1

FIG. 3 is side view of the scrubber of FIG. 1.

FIG. 4 is a front view of the scrubber showing certain internal elements in dashed lines.

FIG. 5 is side view of the scrubber from showing certain internal elements in dashed lines.

FIG. 6 is a top view of the scrubber of FIG. 1.

FIG. 7A is a top view of the motor fan housing with the top removed.

FIG. 7B is a side view of the motor fan blower unit within the motor housing.

FIG. 8A is an enlarged top view of the bottom support plate for the motor fan blower unit.

FIG. 8B is an enlarged side cross section view of the bottom support plate of FIG. 8A.

FIG. 9 is a side view of the filter media assembly within the scrubber of FIG. 1.

FIG. 10 is a side view of the filer media frame.

FIG. 10A is a top view of the filter media frame with the filter media.

FIG. 11 is the top view of the filter media assembly in the scrubber unit when the top motor housing is removed.

FIG. 12A is a top view of the filter frame bottom annular support plate.

FIG. 12B is a top view of the filter frame top annular hold down plate.

FIG. 13 is an enlarged perspective view of the scrubber module.

FIG. 14A is an end view of the scrubber module showing the internal baffles in dashed lines.

FIG. 14B is a cross section view of scrubber module of FIG. 10 at section B-B.

FIG. 15A is a side view of scrubber module within the scrubber housing showing the flow direction of the incoming gas stream.

FIG. 15B is a cross section view of scrubber module within the scrubber showing flow directions of the gas streams, the water level before operation and for comparison the water level during operation.

### DETAILED DESCRIPTION

The description, which follows, and the embodiments described therein, is provided by way of illustration of an example, or examples of particular embodiments of principles and aspects of the present invention. These examples are provided for the purposes of explanation, and not of limitation, of those principles and of the invention. In the description that follows, like parts are marked throughout the specification and the drawings with the same respective reference numerals. The terms top, bottom, upper, lower, upwardly, downwardly, and the like, as used herein, are applied only for convenience in description and should not be taken as limiting the scope of this invention.

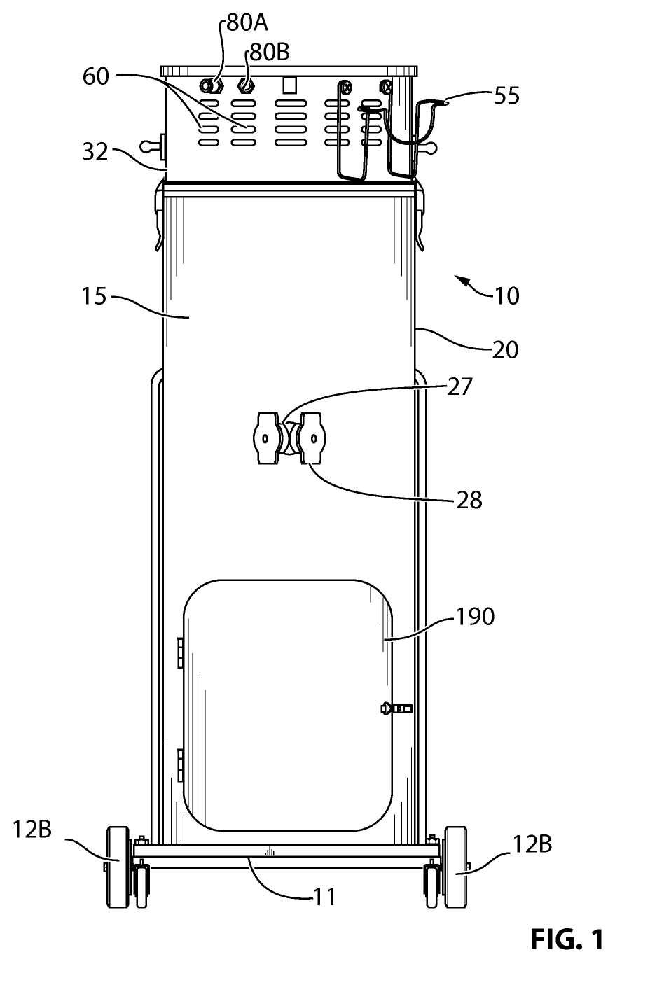

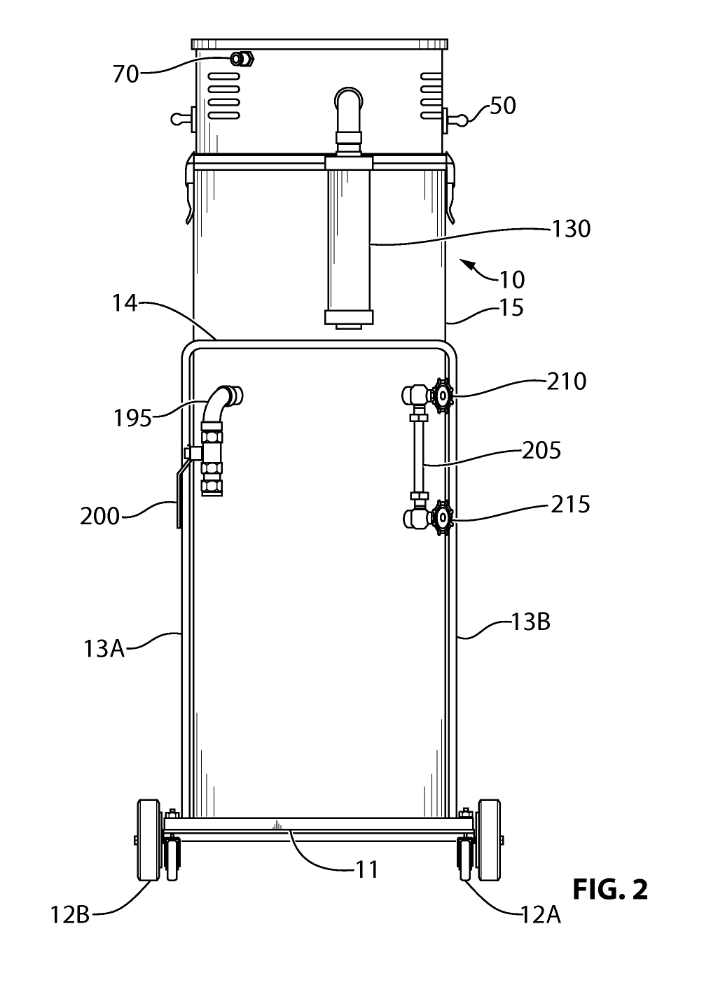

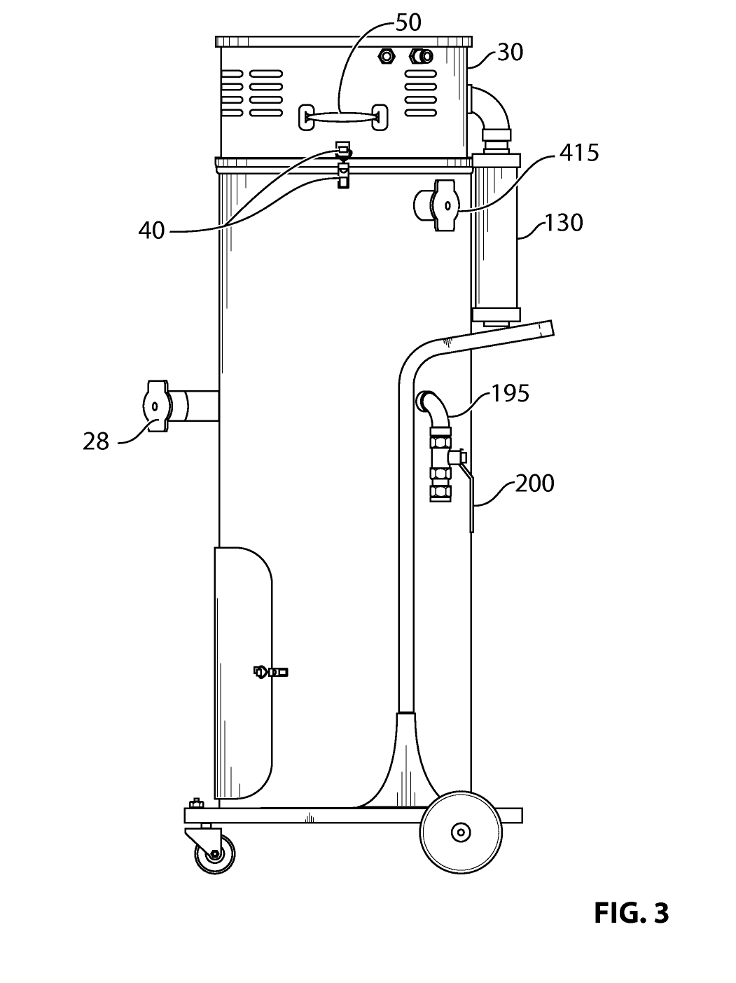

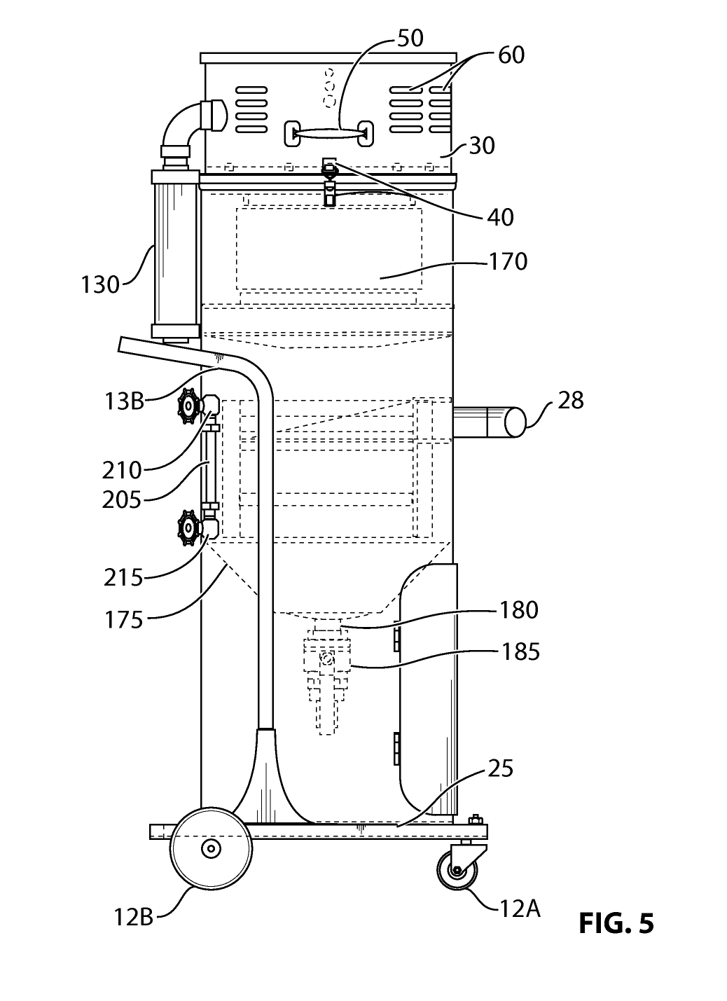

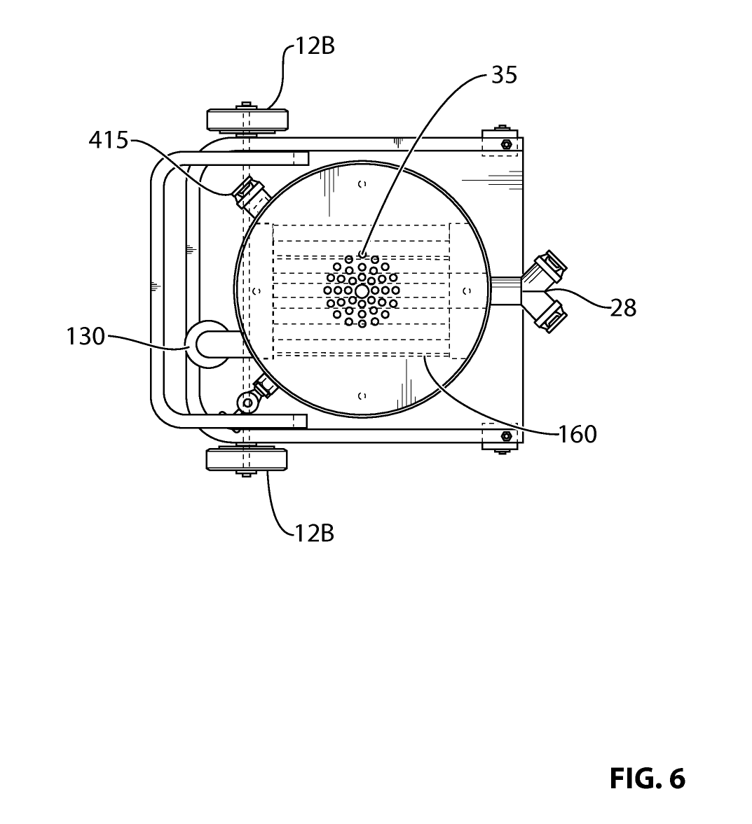

Referring now to FIGS. 1 to 6, there is shown a portable wet scrubber, generally designated 10, constructed in accordance with the principles of this disclosure and comprising a housing 15 having a cylindrical side wall 20 and a bottom end wall 25, an open top end and a contaminated or dirty gas inlet port 27. Although housing 15 preferably has a circular cross section, any suitable cross-sectional configuration can be employed within the purview of the present invention.

A motor housing 30 is removably mounted to the top of housing 15 by a pair of latches 40. Handles 50 on the side wall 32 of motor housing 30 provide for easier removal of motor housing 30. A series of elongated openings 60 are provided around the circumference of side wall 32. Openings 60 dissipate heat buildup within the motor housing 30. Foam sound attenuation material may additionally be provided in the motor housing 30 to reduce noise levels during operation. An inlet port 70 on side wall 32 is adapted for attachment of a compressed air hose for admitting compressed air into a controller assembly (as later described) within motor housing 30. Two outlet ports 80A and 80B are provided on side wall 32 on the opposite side of inlet port 70 for discharging compressed air from controller assembly.

For portability, bottom wall 25 of scrubber 10 is bolted to a cart comprising a flat support plate 11, two swivel wheels 12A, two fixed wheels 12B, vertical members 13A and 13B and handle 14 linking members 13A and 13B.

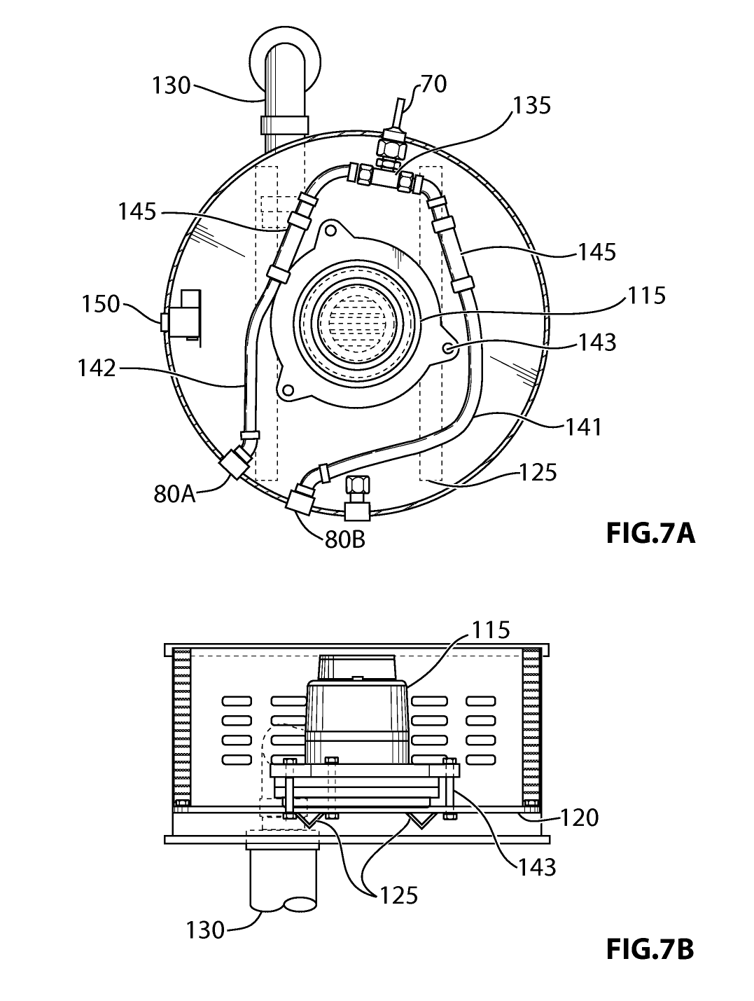

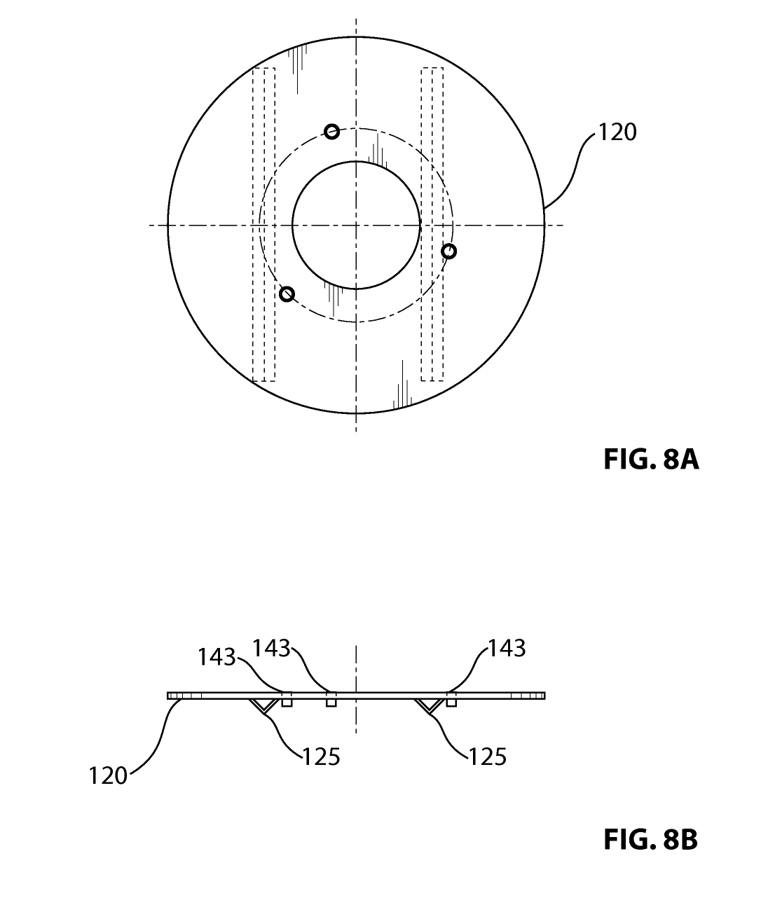

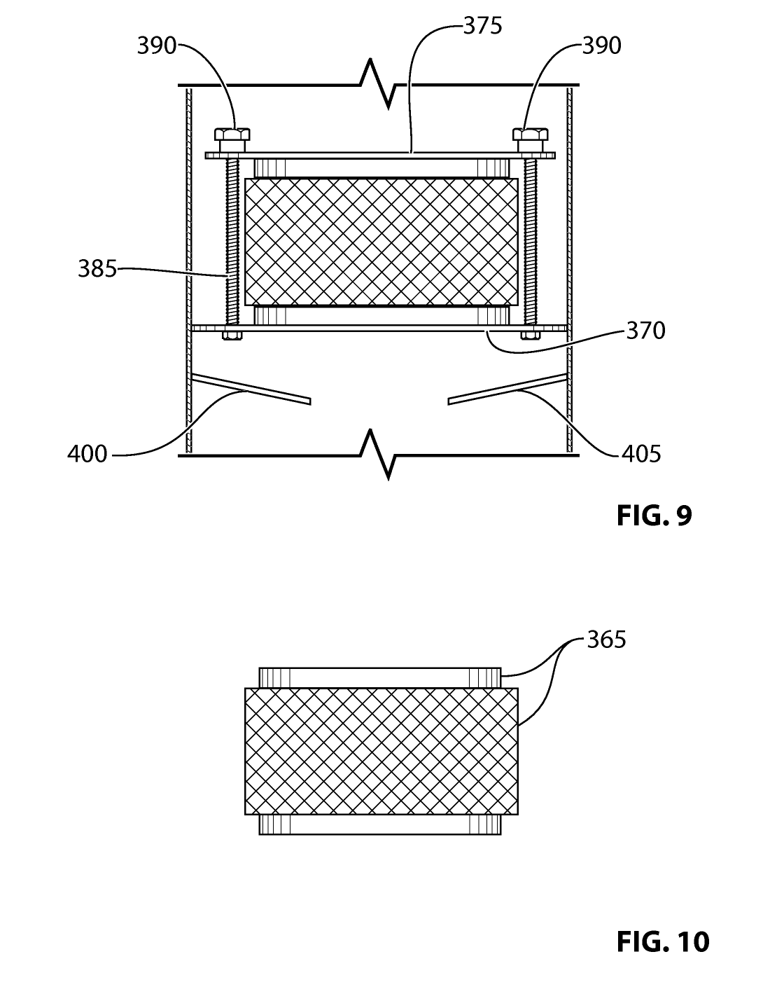

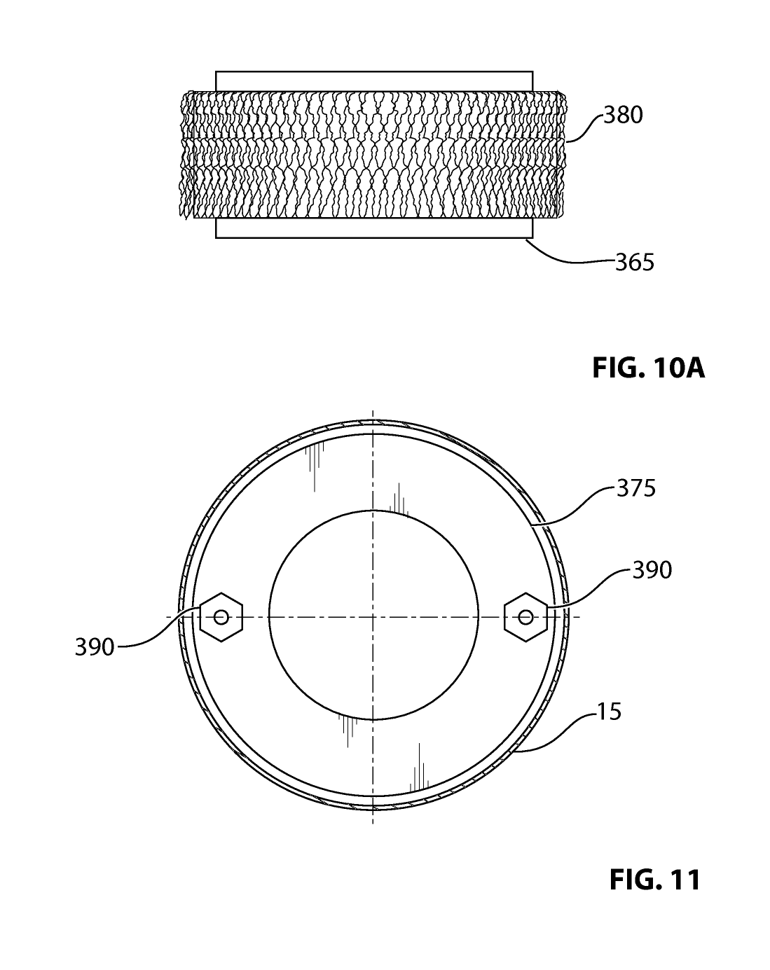

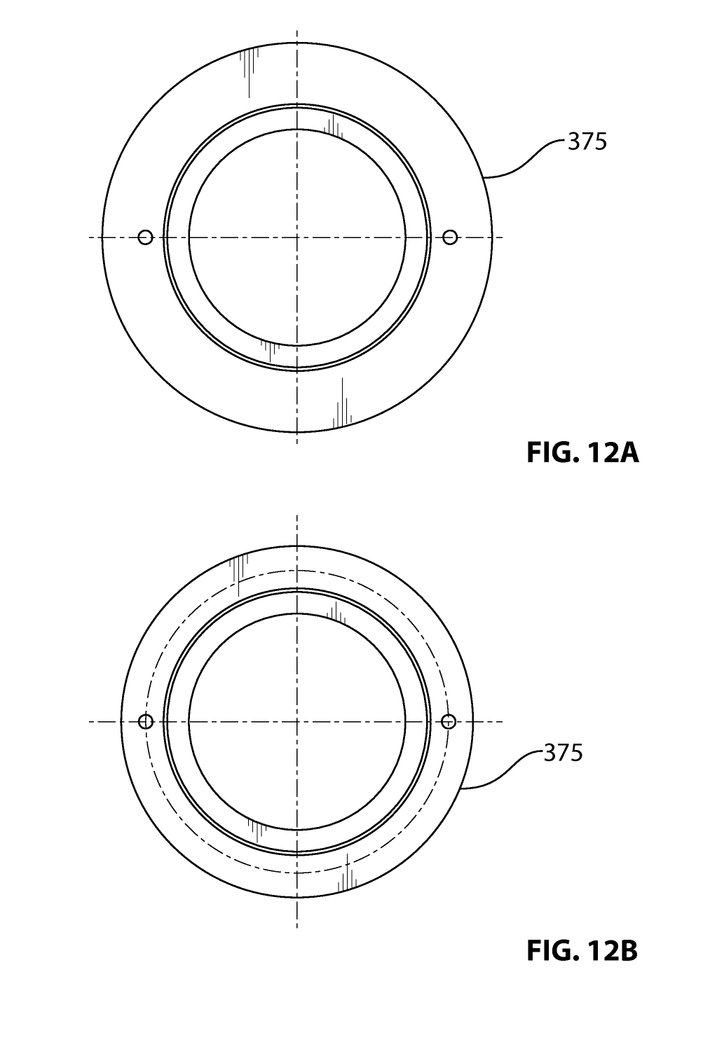

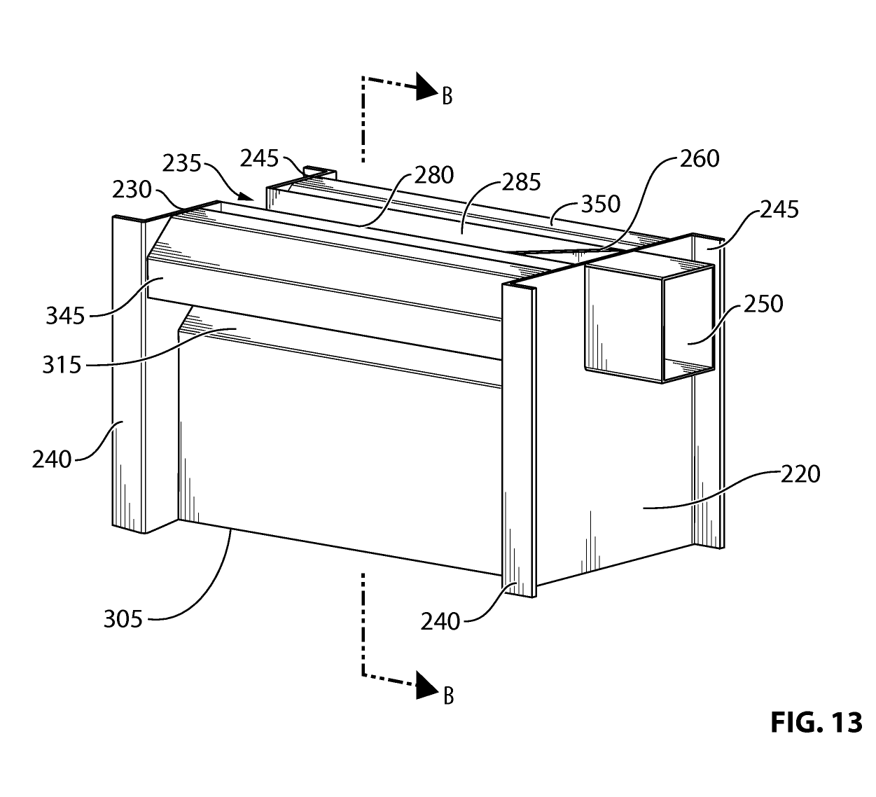

Referring to FIGS. 7A, 7B, 8A, and 8B, motor fan blower unit 115 having bearings for handling moist air is mounted within motor housing 30. “Motor fan blower unit” will be hereinafter referenced as motor. Motor 115 has a 1560 watt blower capable of producing 145 inches of water column and 140 free flow cubic feet per minute (CFM). The motor is bolted via bolts 143 to annular bottom support plate 120. Bottom support plate 120 may optionally be provided with stiffener bars 125 for added strength. An outlet pipe 130 for discharging air from motor housing 30 extends from the motor blower 115 through side wall 32. Outlet pipe 130 includes a silencer to reduce the noise level of the discharging air. A series of openings 35 in the top wall of motor housing 30 provide air intake for the motor.

Compressed air is provided through inlet port 70 to a tee 135. Tee 135 diverts the incoming compressed air into hoses 141 and 142 which extend circumferentially around motor 115 to outlet ports 80A and 80B in side wall 32. Each hose is provided with an air flow switch 145. When a pneumatic tool is attached to contaminated gas inlet duct 27 of scrubber 10, motor 115 is automatically turned on by air switches 145. A motor starter controller 150 is also provided on side wall 32 for setting the operation of motor 115. The motor starter controller has three operational settings, namely on, off and auto. The ‘on’ setting allows the scrubber unit to continuously run without shutting off. The ‘off’ setting turns off the unit. The ‘auto’ setting allows the compressed air to turn on the scrubber unit. The auto setting has a 10 second off delay. The delay allows a user to temporarily release the pneumatic tool without shutting off the scrubber. A rack 55 is optionally mounted to side wall 32 of motor housing for storing hoses.

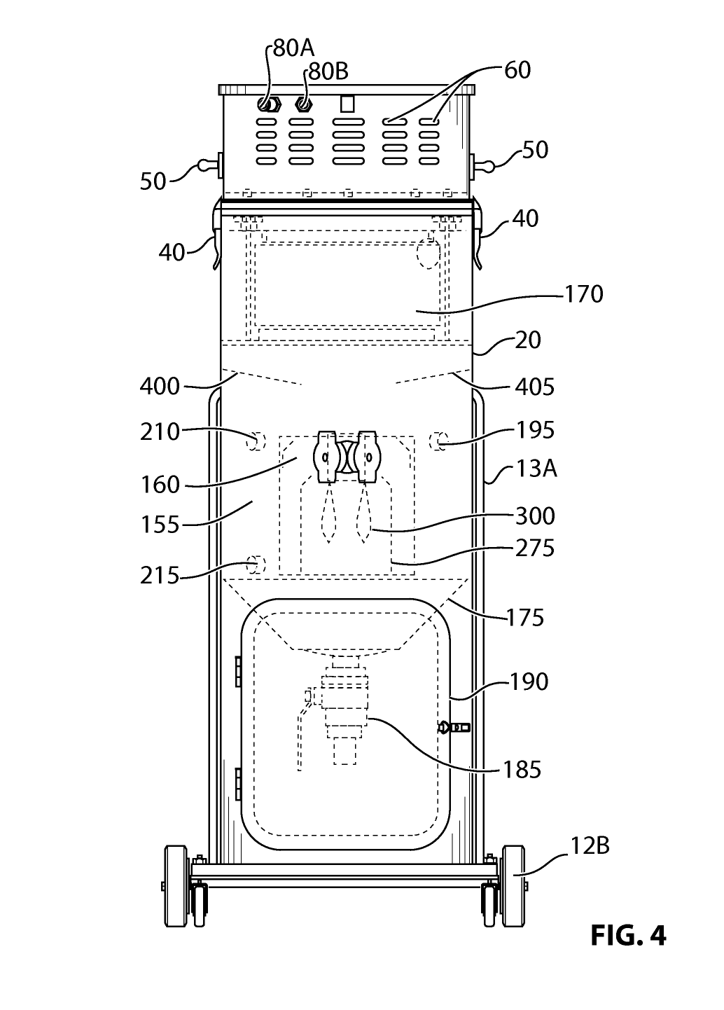

Referring to FIGS. 4, 5 and 6, housing 15 includes a middle compartment having a fluid reservoir 155 and a venturi scrubbing module 160 (also called a scrubbing module) mounted to the inside wall of housing 15, a lower compartment containing the lower section of fluid reservoir 155 and a waste effluent drain assembly 165 for draining fluid reservoir 155, and, an upper compartment containing filter media assembly 170.

The bottom portion of fluid reservoir 155 has a conically shaped bottom wall 175 having a drain outlet 180. A shut-off valve 185 is fitted to drain outlet 180 for controlling the removal of waste effluent from the fluid reservoir bottom. A hose [not shown] may be affixed to valve 185 to direct the waste effluent to an area remote from scrubber 10. The lower compartment of housing 15 is accessible by a hinged door 190 in side wall 20.

Contaminated gas inlet duct 27 on side wall 20 is adapted to receive a dirty gas stream from the exhaust hose of a connected pneumatic tool, such as an orbital sander. Inlet duct 27 may comprise a single hose adapter for receiving one pneumatic tool hose or a Y-shaped fitting 28 with two hose adapters for simultaneous connection of two pneumatic tool hoses.

Water, or any other suitable liquid, from an external water supply via a hose (not shown) is introduced into water inlet port 195 and flows into fluid reservoir 155. Water inlet port 195 is provided with a shut off valve 200. The water level in fluid reservoir 155 is monitored by a water level gauge such as a sight glass 205 disposed between two valved ports 210 and 215 in housing side wall 20. Sight glass 205 is marked with low and high water levels. When the desired water level is shown on sight glass 205 shut off valve 200 is closed and the external water supply is turned off.

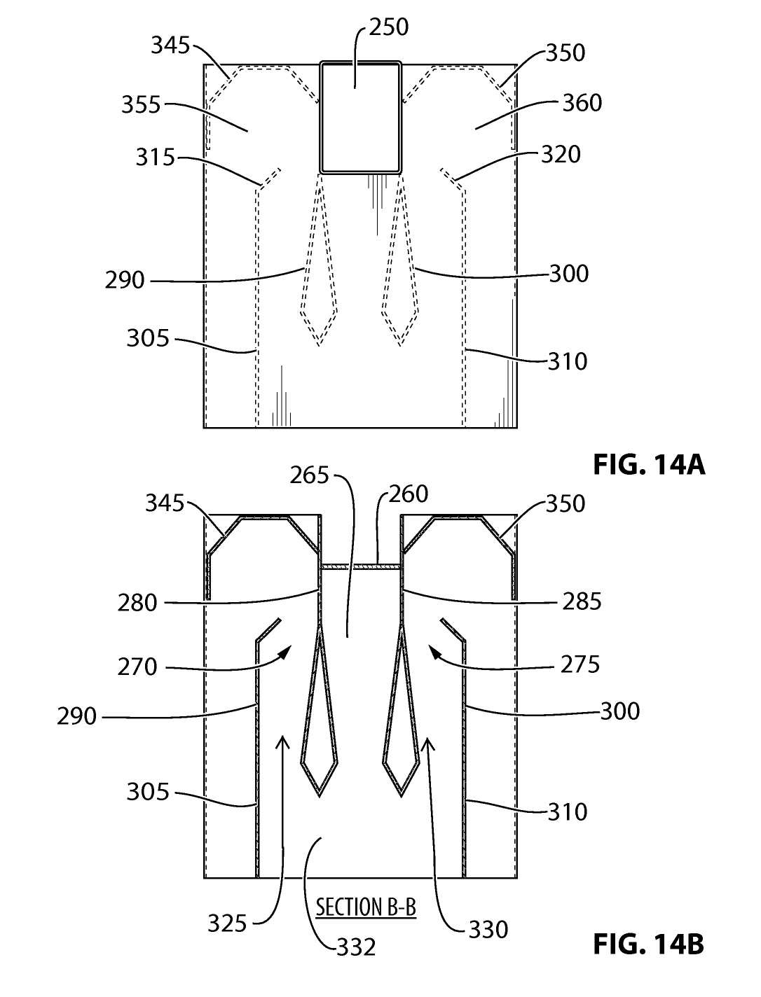

Referring to FIGS. 13, 14, 15A and 15B, venturi scrubbing module 160 is mounted above the lower conical portion of fluid reservoir 155. The venturi scrubbing module 160 comprises a first end wall 220 having a quadrangular notch 225 at its top centre and a spaced apart second end wall 230 having an identical sized quadrangular notch 235 at its top centre. Each end wall has outward facing flanges 240 and 245 extending from the vertical edges of end walls 220 and 230. The flanges provide surfaces for affixing the venturi scrubbing module 160 to the inner side wall of housing 15, such as by welding. End walls 220 and 230 have the same configurations and dimensions. A quadrangular duct 250 projects from notch 225. The duct 250 abuts the interior side wall of housing 15 at gas inlet duct 27. An adapter from rectangular to circular (not shown) is fitted to duct 250 for connection to inlet duct 27. Duct 250 may be cylindrically shaped in which case an adapter is not required.

The venturi scrubbing module 160 further comprises a plurality of baffles forming a plurality of channels. An elongate plate having a width equal to the width of notches 225 and 235 is affixed to the top of end wall notch 225 and to the bottom of end wall notch 235, to form an angled top wall 260 of an inner channel 265. Elongate baffles 270 and 275 are arranged to extend downwardly from the top edges of end walls 220 and 230 and longitudinally from end wall 220 to end wall 230 at the side edges of notches 225 and 235. Baffles 270 and 275 form the side walls of inner channel 265. Baffles 270 and 275 extend approximately three quarters of the distance between the top and bottom edges of end walls 220 and 230. Baffles 270 and 275 have flat sections 280 and 285 respectively and lower bulbous like sections 290 and 300. Lower sections 290 and 330 may comprise a combination of angled flat surfaced plate segments formed into a generally tear drop or diamond shape at the opposite end. Lower sections 290 and 300 may alternatively have curved surfaces to from a rounded shape. Sections 290 and 300 intensify turbulence of the gas stream during the scrubbing process.

Baffle plates 305 and 310 extend upwardly from the bottom edges of end walls 220 and 230 and longitudinally between end walls 220 and 230. Baffle plates 305 and 310 have inwardly angled top ends 315 and 320 respectively. Baffle plates 305 and 310 are arranged approximately equidistant between notches 225 and 235 and the side edges of end walls 220 and 230. Baffle plates 305 and 310 extend upwardly to approximately the same height as the bottom of duct 250, thereby forming channel 325 between baffle 270 and baffle 265 and channel 330 between baffle 275 and baffle 275. Since baffles 270 and 275 do not extend the entire height of the end walls, channels 325 and 330 open into a single open lower chamber 332.

Upper baffles plates 345 and 350 comprise plate segments formed into a substantially arcuate shape. Baffles plates 345 and 350 extend longitudinally between end walls 220 and 230 are arranged above baffle plates 305 and 310, thereby forming upper channels 355 and 360. Alternatively, upper baffles plates 345 and 350 may consist of single rounded plates.

Filter media assembly 170 is located in the upper compartment of housing 15 below motor housing 30. Filter media assembly 170 comprises a filter media frame 365 supported by an annular bottom support plate 370, an annular top plate 375, filter media 380 arranged within frame 365 between bottom plate 370 and top plate 375, threaded rods 385 between bottom and top plates and removable threaded knobs 390 at top end of rods. Knobs 390 are used to tighten top plate 375 against bottom plate 370 to hold down filter frame 365. Removal of knobs 390, permits removal of top plate 375 for replacing filter media 380. Filter media 380 removes entrained moisture in the cleansed gas stream before it exits scrubber 10. Filter media 380 may consist of stainless steel mesh or other suitable media material or mist eliminators designed for removal of entrained moisture for the specific type of gas stream being cleansed.

Arranged below filter media assembly 170 and above the venturi scrubber module 60 are a pair half-moon shaped baffles 400 and 405 extending inwards from side wall 20 of housing 15. Baffles 400 and 405 only extend partly into the interior of housing 15 thereby forming an opening 410. Baffles 400 and 405 remove entrained water in the gas stream before entry into filter media assembly 170. The downward angle of the baffles cause water captured by baffles 400 and 405 to drip downwards in the housing.

The cleansing of a gas stream contaminated with aluminum particulates generates hydrogen gas which is discharged through relief valve 415 arranged through side wall 20 in the upper section of housing 15. Relief valve 415 is normally in a shut off position during operation of the scrubber and automatically opens to discharge any built up hydrogen gas when the scrubber unit is turned off.

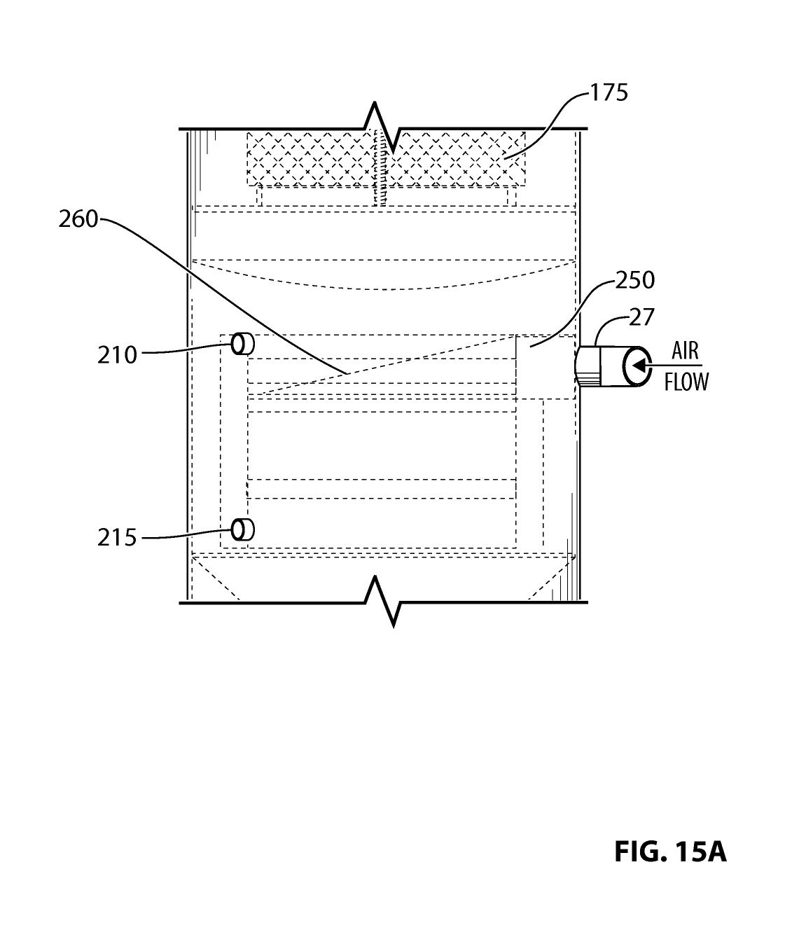

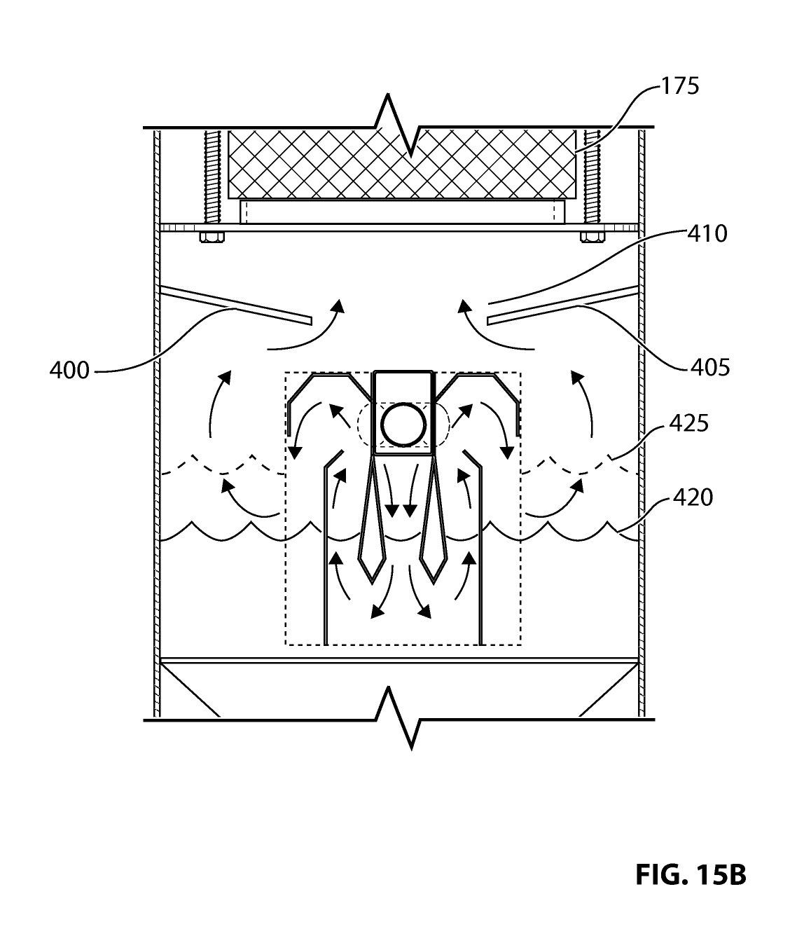

In operation, a water supply hose is connected to water inlet valve 200 is opened. Water fills fluid reservoir 155 until the desired water level 420 is shown on sight glass 205. Water supply valve 200 is then turned off. A compressed air hose is connected to inlet port 70. A pneumatic tool exhaust hose with a particle entrained gas stream (such as dust from a sander) is connected to inlet port 28 causing air flow switches 145 to turn on motor 115. As illustrated in FIGS. 14A, 14B, 15A and 15B, the gas stream enters through duct 250 of venturi scrubbing module 160 and is forced down through inner channel 265. The velocity of the gas stream causes turbulence in the water shown as 425. Some water becomes entrained in the gas stream as droplets. The water acts as a separator, and a majority of particulates in the contaminated gas stream fall to the bottom of reservoir 155 immediately. Those entrained particles that manage to escape the first stage of cleansing in inner channel 265, are forced through thick curtains of water, and are deflected by baffles into the water turbulence through several channels, separating the remaining particulates from the gas stream. In particular, the gas stream is directed towards channel 332 and around the bottom of baffles 270 and 275, into channels 325 and 330. The angled ends 315 and 320 of baffles 305 and 310 direct the gas stream towards surfaces 280 and 285 of baffles 270 and 275 and upwardly towards upper channels 345 and 350. Arcuate upper channels 345 and 350 direct the cleansed gas stream in a generally curved outward flow direction exiting the venturi scrubbing module. The moist cleansed gas is drawn up through scrubber 10 by motor 115 and passes through the stainless steel media assembly 170, where remaining moisture is removed from the cleansed gas. The particulate matter which has settled to the conical bottom of reservoir 155 may be removed through drain valve 185.

While the principles of the invention have been shown and described in connection with specific embodiments, it is to be understood that such embodiments are by way of example and are not limiting As is evident from the foregoing description, certain aspects of the present invention are not limited by the particular details of the mobile stand illustrated in the drawings. Other modifications and applications, or equivalents, will occur to those skilled in the art. The terms “having”, “comprising” and “including” and similar terms as used in the foregoing specification are used in the sense of “optional” or “may include” and not as “required”. Many changes, modifications, variations and other uses and applications of the present construction will, however, become apparent to those skilled in the art after considering the specification and attached drawings. All such changes, modifications, variations and other uses and applications which do not depart from the spirit and scope of the invention are deemed to be covered by the invention which is limited only by the claims that follow. The scope of the disclosure is not intended to be limited to the embodiments shown herein, but is to be accorded the full scope consistent with the claims, wherein reference to an element in the singular is not intended to mean “one and only one” unless specifically so stated , but rather one or more.

What is claimed is:

1. A portable wet scrubber comprising:
a main housing having a closed first end wall and an open second end wall;
a detachable top mounted motor housing including a fan blower adapted to draw gas from the main housing and to discharge the gas from the motor housing;
said main housing having upper, middle and lower sections therein;
said upper section comprising a filtering element;
said middle section comprising a fluid reservoir and a scrubbing module disposed therein;
said scrubbing module cooperating with said upper and lower sections;
a contaminated gas inlet port arranged in the side wall of the main housing cooperating with an inlet duct of the scrubbing module;
said lower section comprising the lower portion of the fluid reservoir and means for removal of particulates extracted from the contaminated gas;
said scrubbing module comprising a plurality of baffles disposed longitudinally between a pair of end walls of the scrubbing module and arranged to define a plurality of associated channels therethrough;
said channels comprising a first inner channel cooperating with the inlet duct, a pair of second inner channels adjacent the end section of the first inner channel and a pair of third channels, wherein said second channels converge into an associated chamber in communication with the first and third channels and wherein said third channels are disposed adjacent the first channel in cooperation with the second channels.

2. The portable wet scrubber as claimed in claim 1 wherein first end wall of the housing is affixed to a cart having a platform, a plurality of wheels affixed to the platform, a pair of members extending from the platform and conjoining with a cross member.

3. The portable wet scrubber as claimed in claim 1 wherein said first channel comprises an angled top wall plate and a pair of inner baffles each extending generally orthogonally from each side of the top wall.

4. The portable wet scrubber as claimed in claim 1 wherein said first channel comprises an angled top wall plate and a pair of inner baffles each extending generally orthogonally from each side of the top wall, a pair of spaced apart longitudinal baffle plates are disposed parallel to each inner baffle to form a pair of second channels adjacent each side of first channel, wherein each longitudinal baffle plate has an angled end section extending towards said inner baffle.

5. The portable wet scrubber as claimed in claim 1 wherein the third channels are generally arcuate in shape and are disposed in spaced relationship from the angled end of each longitudinal baffle plate.

6. The portable wet scrubber as claimed in claim 1 wherein said first channel comprises an angled top wall plate and a pair of inner baffles each extending generally orthogonally from each side of the top wall, each inner baffle includes a flat section proximate the top wall and an opposing bulbous like end section.

7. The portable wet scrubber as claimed in claim 1 wherein said first channel comprises an angled top wall plate and a pair of inner baffles each extending generally orthogonally from each side of the top wall, each inner baffle includes a flat section proximate the top wall and an opposing bulbous like end section, said bulbous ends of the inner baffles comprise a plurality of plate segments formed into a diamond shape.

8. The portable wet scrubber as claimed in claim 1 wherein said first channel comprises an angled top wall plate and a pair of inner baffles each extending generally orthogonally from each side of the top wall, each inner baffle includes a flat section proximate the top wall and an opposing bulbous like end section, said bulbous ends comprise a generally spherical shape.

9. The portable wet scrubber according to claim 1 wherein the fluid reservoir has a generally conical shaped bottom wall having a valved drain.

10. The portable wet scrubber according to claim 1 further comprising a fluid inlet port communicating with the reservoir.

11. The portable wet scrubber according to claim 1 comprising means for controlling the fluid level in the reservoir.

12. The portable wet scrubber according to claim 1 further comprising controller means for selective operation of the fan.

13. The portable wet scrubber according to claim 1 wherein the filter element comprises a filter frame and filer media.

14. The portable wet scrubber according to claim 1 further comprising a pair of opposed angled baffles disposed between the scrubbing module and the filter element, said baffles extending inwardly from the side wall of the main housing to form an opening therebetween.

15. The portable wet scrubber according to claim 1 further comprising an outlet port in the side wall of the housing at the filter element section, said outlet port having means for discharging built up gas from filter element section.

16. A portable wet scrubber having a main housing including a closed first end wall and an open second end wall, comprising:
a detachable top mounted motor housing including a fan blower adapted to draw gas from said main housing and to discharge the gas from the motor housing;
said main housing having upper, middle and lower sections therein;
said upper section comprising a filtering element;
said middle section comprising a fluid reservoir and a scrubbing module disposed therein;
said scrubbing module cooperating with said upper and lower sections;
a contaminated gas inlet port arranged in the side wall of the main housing cooperating with an inlet duct of the scrubbing module;
said lower section comprising the lower portion of the fluid reservoir and means for removal of particulates extracted from the contaminated gas;
said scrubbing module comprising a plurality of baffles disposed longitudinally between a pair of end walls of the scrubbing module and arranged to define a plurality of associated channels therethrough;
said channels comprising a first inner channel cooperating with the inlet duct, a pair of second inner channels adjacent the end section of the first inner channel and a pair of third channels, wherein said second channels converge into an associated chamber in communication with the first and third channels and wherein said third channels are disposed adjacent the first channel in cooperation with the second channels.

17. A portable wet scrubber having a main housing including a closed first end wall and an open second end wall, comprising:
a detachable top mounted motor housing including a fan blower adapted to draw gas from said main housing and to discharge the gas from the motor housing;
said main housing having upper, middle and lower sections therein;
said upper section comprising a filtering element;
said middle section comprising a fluid reservoir and a scrubbing module disposed therein;
said scrubbing module cooperating with said upper and lower sections;
a contaminated gas inlet port arranged in the side wall of the main housing cooperating with an inlet duct of the scrubbing module;
said lower section comprising the lower portion of the fluid reservoir and means for removal of particulates extracted from the contaminated gas;
said scrubbing module comprising a plurality of baffles disposed longitudinally between a pair of end walls of the scrubbing module and arranged to define a plurality of associated channels therethrough;
said channels comprising a first inner channel cooperating with the inlet duct, a pair of second inner channels adjacent the end section of the first inner channel and a pair of third channels, wherein said second channels converge into an associated chamber in communication with the first and third channels and wherein said third channels are disposed adjacent the first channel in cooperation with the second channels;
said first end wall of the housing is affixed to a cart having a platform, a plurality of wheels affixed to the platform, a pair of members extending from the platform and conjoining with a cross member.

18. The portable wet scrubber according to claim 1 wherein the main housing is generally cylindrical in shape.
